(19) United States
(12) Patent Application Publication
(10) Pub. No.: US 2020/0228235 A1
(43) Pub. Date: Jul. 16, 2020

(54) DATA RECOVERY IN UNRELIABLE PACKET NETWORKS

(71) Applicant: QUALCOMM Incorporated, San Diego, CA (US)

(72) Inventors: Laurence George RICHARDSON, Ely (GB); Robin HEYDON, Cambridge (GB)

(21) Appl. No.: 16/245,100

(22) Filed: Jan. 10, 2019

(51) Int. Cl. H04L 1/00; H04W 72/00; H04L 29/08; H04L 1/08

(52) U.S. Cl. CPC H04L 1/0045; H04W 72/005; H04W 4/80; H04L 1/08; H04L 69/324

(57) ABSTRACT

The apparatus receives a plurality of broadcasted segmented messages from one or more nodes. Each segmented message of the segmented messages includes redundancy error coding. The apparatus reassembles the segmented messages into a plurality of PDUs. Each PDU of the plurality of PDUs has a sequence number. The apparatus determines that one or more PDUs of the plurality of PDUs failed to decode upon attempting to decode each of the PDUs, or that the one or more PDUs are missing from the plurality of PDUs based on the sequence number. The apparatus constructs at least one PDU of the one or more PDUs based on the redundancy error coding in decoded PDUs other than the at least one PDU. The apparatus reassembles the PDUs into an object based on the sequence number for each PDU.

### BACKGROUND

### Field

The present disclosure relates generally to communication systems, and more particularly, to data recovery in unreliable packet networks.

### Background

Packet-based networks in a digital communications system generally define the size of a Maximum Transmission Unit (MTU). A data object whose size exceeds the size of the MTU may still be sent from a sender to a receiver via the network provided that a scheme for fragmentation of the object and reassembly of the object is implemented. A network, such as a Bluetooth Mesh network, may use an unreliable system of transmission in which the receiver does not acknowledge receipt of the individual messages and hence the sender does not know whether a fragment has been successfully received. Where a large data object is fragmented into many pieces for the purposes of transmission via a network that uses an unreliable system of transmission, e.g., using multiple hops, there is typically a high probability that one or more fragments will fail to be delivered successfully to the receiver.

A Bluetooth Mesh network may be used to establish a many-to-many (m:m) relationship between wireless devices. Wireless devices in the Bluetooth Mesh network may relay data to other devices that may not be in direct radio range of the originating device. As a result, mesh networks may span very large physical areas and contain a large amount of devices. Bluetooth mesh networks allow devices to be installed and to communicate with each other across a very large physical areas, for example, shopping malls, airport, sporting venues, and the like. These physical areas may have physical barriers and/or walls such that direct radio contact between devices installed in different regions of the location may not be possible. Bluetooth mesh networks may overcome this issue by designating some of the wireless devices within the Bluetooth mesh network as a relay device.

Relay devices retransmit messages received from other devices, and are able to communicate with devices that may not be within radio range of the device that originally broadcasted the message. A message may be related multiple times or “hops”, with a maximum of 127 hops being possible. However, as messages are being propagated and/or retransmitted the possibility of errors being introduced and/or data packets being lost and not reaching the final destination increases. Thus, there exists a need for a receiver in an unreliable packet network to be able to recreate the original data object accurately even if some of the fragments that it has received are missing or corrupted.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

BLE was developed and adopted in various applications in which an infrequent transfer of data occurs. BLE exploits the infrequent transfer of data by using a low duty cycle operation, and switching at least one of the central device and/or peripheral device(s) to a sleep mode in between data transmissions. Example applications that use BLE include battery-operated sensors and actuators in various medical, industrial, consumer, and fitness applications. The BLE applications often connect to devices such as BLE enabled smart phones, tablets, and laptops.

Packet-based networks in a digital communications system generally define the size of an MTU. A data object whose size exceeds the size of the MTU may still be sent from a sender to a receiver via the network provided that a scheme for fragmentation of the object (where each fragment is smaller than or equal to the MTU size) and reassembly of the object is implemented.

A network, such as a Bluetooth Mesh network, may use an unreliable system of transmission in which the receiver does not acknowledge receipt of the individual messages and hence the sender does not know whether a fragment has been successfully received. The receiver may not have any mechanism to request re-transmission of a fragment the receiver has not received. The network has a certain probability of a packet being delivered successfully from one node to the next node.

A message path comprising of multiple hops, such as a Bluetooth Mesh network, has a combined probability of a packet being delivered successfully from the sender to the receiver, the overall probability being the product of the probabilities associated with each hop, and this combined probability will reduce in proportion to the number of hops. There are many types of data, such as a firmware update image, where it is crucial that the original object is reassembled without errors and in its entirety.

Where a large data object is fragmented into many pieces for the purposes of transmission via a network that uses an unreliable system of transmission, e.g., using multiple hops, there is typically a high probability that one or more fragments will fail to be delivered successfully to the receiver.

There exists a need for an error correction technique to enable a receiver in an unreliable packet network to be able to recreate the original data object accurately even if some of the fragments that it has received are missing or corrupted.

The error correction techniques of the present disclosure promote error-correction in unreliable packet networks, e.g., Bluetooth mesh networks, to process the large data object prior to transmission by adding error correction coding to each fragment such that, provided sufficient fragments are received, the missing and/or corrupted fragments may be reconstructed from the error correction data and the entire data object may then be recovered. The techniques therefore provide error correction for the entire packet.

In an aspect of the disclosure, a method, a computer-readable medium, and an apparatus are provided. The apparatus may receive a plurality of broadcasted segmented messages from one or more nodes. In some aspects, each segmented message of the segmented messages includes redundancy error coding. The apparatus may reassemble the segmented messages into a plurality of packet data units (PDUs). In some aspects, each PDU of the plurality of PDUs has a sequence number. The apparatus may determine that one or more PDUs of the plurality of PDUs failed to decode upon attempting to decode each of the PDUs, or that the one or more PDUs are missing from the plurality of PDUs based on the sequence number. The apparatus may construct at least one PDU of the one or more PDUs based on the redundancy error coding in decoded PDUs other than the at least one PDU. The apparatus may reassemble the PDUs into an object based on the sequence number for each PDU.

In another aspect of the disclosure, a method, a computer-readable medium, and an apparatus are provided. The apparatus may code an object based on a redundancy error code. The apparatus may split the object into a plurality of PDUs. In some aspects, each of the PDUs has a sequence number and a corresponding portion of the redundancy error code. The apparatus may segment each of the PDUs into a plurality of segmented messages. The apparatus may broadcast the segmented messages to one or more nodes.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless network in accordance with certain aspects of the disclosure.

FIG. 2 is block diagram of a wireless device in accordance with certain aspects of the disclosure.

FIG. 3 is a diagram illustrating a Bluetooth Mesh architecture in accordance with certain aspects of the disclosure.

FIG. 4 is a diagram illustrating wireless communication in accordance with certain aspects of the disclosure.

FIG. 5 is a diagram illustrating wireless communication in accordance with certain aspects of the disclosure.

FIG. 6 is a flowchart of a method of wireless communication.

FIG. 7 is a conceptual data flow diagram illustrating the data flow between different means/components in an exemplary apparatus.

FIG. 8 is a diagram illustrating an example of a hardware implementation for an apparatus employing a processing system.

FIG. 9 is a flowchart of a method of wireless communication.

FIG. 10 is a conceptual data flow diagram illustrating the data flow between different means/components in an exemplary apparatus.

FIG. 11 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

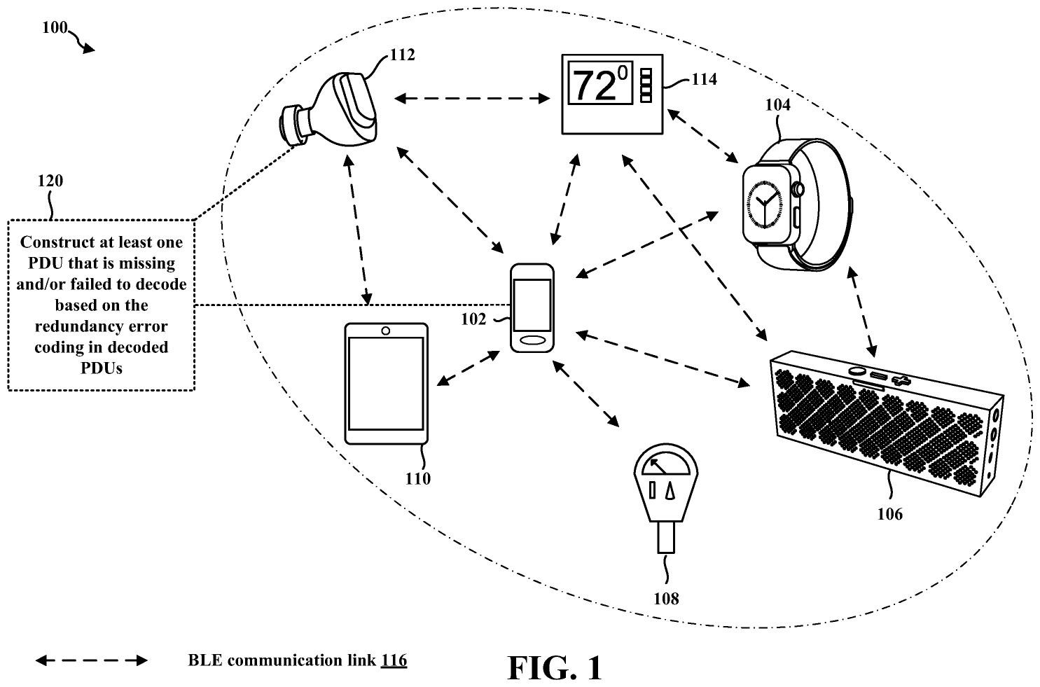

FIG. 1 illustrates an example wireless network 100 in accordance with certain aspects of the disclosure. Within the wireless network 100, a device 102 may connect to and establish a BLE communication link 116 with one or more devices 104, 106, 108, 110, 112, 114 using a BLE protocol or a modified BLE protocol. The BLE protocol is part of the BT core specification and enables radio frequency communication operating within the globally accepted 2.4 GHz Industrial, Scientific & Medical (ISM) band.

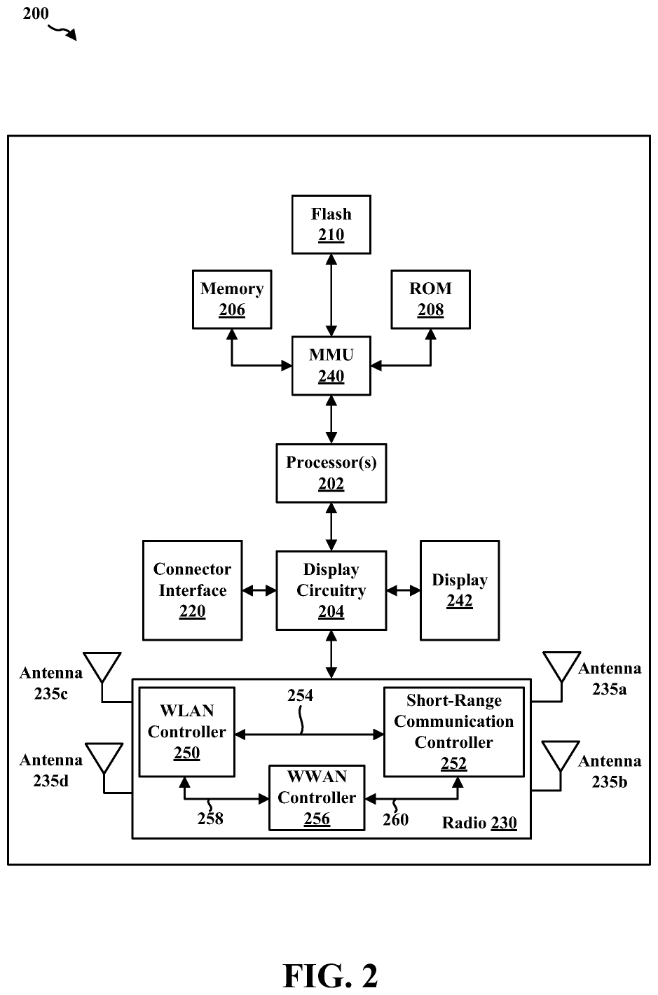

The device 102 may include suitable logic, circuitry, interfaces, processors, and/or code that may be used to communicate with one or more devices 104, 106, 108, 110, 112, 114 using the BLE protocol or the modified BLE protocol as described below in connection with any of FIGS. 2-11. The device 102 may operate as an initiator to request establishment of a link layer (LL) connection with an intended peripheral device 104, 106, 108, 110, 112, 114.

Examples of the device 102 may include a cellular phone, a smart phone, a session initiation protocol (SIP) phone, a mobile station (STA), a laptop, a personal computer (PC), a desktop computer, a personal digital assistant (PDA), a satellite radio, a global positioning system, a multimedia device, a video device, a digital audio player (e.g., MP3 player), a camera, a game console, a tablet, a smart device, a wearable device (e.g., smart watch, wireless headphones, etc.), a vehicle, an electric meter, a gas pump, a toaster, a thermostat, a hearing aid, a blood glucose on-body unit, an Internet-of-Things (IoT) device, or any other similarly functioning device.

Examples of the one or more devices 104, 106, 108, 110, 112, 114 may include a cellular phone, a smart phone, a SIP phone, a STA, a laptop, a PC, a desktop computer, a PDA, a satellite radio, a global positioning system, a multimedia device, a video device, a digital audio player (e.g., MP3 player), a camera, a game console, a tablet, a smart device, a wearable device (e.g., smart watch, wireless headphones, etc.), a vehicle, an electric meter, a gas pump, a toaster, a thermostat, a hearing aid, a blood glucose on-body unit, an IoT device, or any other similarly functioning device. Although the device 102 is illustrated in communication with six devices 104, 106, 108, 110, 112, 114 in the wireless network 100, the device 102 may communicate with more or fewer than six devices within the wireless network 100 without departing from the scope of the present disclosure.

In certain configurations, the wireless network 100 may be a Bluetooth mesh network such that the device 102 and the one or more devices 104, 106, 108, 110, 112, and 114 may be configured to communicate with one another. Devices that are configured to be part of a Bluetooth mesh network may be referred to as nodes. Examples of product types that may be nodes in a Bluetooth mesh network may include: lights, light switches, thermostats, window locks, occupancy sensors, parking meters, and the like. As such, any node within a Bluetooth mesh network may be configured to communicate with any other node within the Bluetooth mesh network.

Referring again to FIG. 1, in certain aspects, the device 102 and/or the device 112 may be configured to construct at least one PDU that is missing and/or failed to decode based on the redundancy error coding in decoded PDUs (120), e.g., as described below in connection with any of FIGS. 2-11.

FIG. 2 is block diagram of a wireless device 200 in accordance with certain aspects of the disclosure. The wireless device 200 may correspond to, e.g., devices 102, 104, 106, 108, 110, 112, 114 described above in connection with FIG. 1. In certain aspects, the wireless device 200 may be a BLE enabled device.

As shown in FIG. 2, the wireless device 200 may include a processing element, such as processor(s) 202, which may execute program instructions for the wireless device 200. The wireless device 200 may also include display circuitry 204 which may perform graphics processing and provide display signals to the display 242. The processor(s) 202 may also be coupled to memory management unit (MMU) 240, which may be configured to receive addresses from the processor(s) 202 and translate the addresses to address locations in memory (e.g., memory 206, ROM 208, Flash memory 210) and/or to address locations in other circuits or devices, such as the display circuitry 204, radio 230, connector interface 220, and/or display 242. The MMU 240 may be configured to perform memory protection and page table translation or set up. In some embodiments, the MMU 240 may be included as a portion of the processor(s) 202.

As shown, the processor(s) 202 may be coupled to various other circuits of the wireless device 200. For example, the wireless device 200 may include various types of memory, a connector interface 220 (e.g., for coupling to the computer system), the display 242, and wireless communication circuitry (e.g., for Wi-Fi, BT, BLE, cellular, etc.). The wireless device 200 may include a plurality of antennas 235a, 235b, 235c, 235d, for performing wireless communication with, e.g., wireless devices in a WPAN.

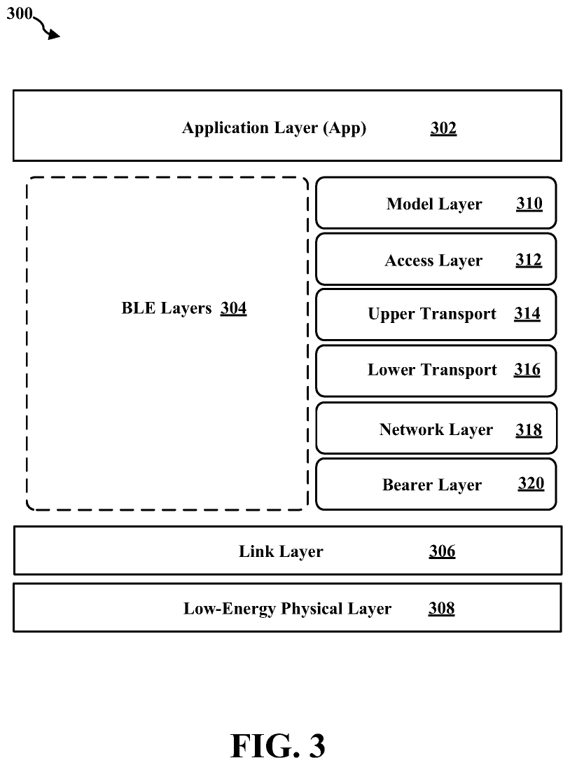

In certain aspects, the wireless device 200 may include hardware and software components (a processing element) configured to construct at least one PDU that is missing and/or failed to decode based on the redundancy error coding in decoded PDUs, e.g., using the techniques described below in connection with any FIGS. 3-11. The wireless device 200 may also comprise BT and/or BLE firmware or other hardware/software for controlling BT and/or BLE operations.

The wireless device 200 may be configured to implement part or all of the techniques described below in connection with any of FIGS. 3-11, e.g., by executing program instructions stored on a memory medium (e.g., a non-transitory computer-readable memory medium) and/or through hardware or firmware operation. In other embodiments, the techniques described below in connection with any of FIGS. 3-11 may be at least partially implemented by a programmable hardware element, such as a field programmable gate array (FPGA), and/or an application specific integrated circuit (ASIC).

In certain aspects, radio 230 may include separate controllers configured to control communications for various respective radio access technology (RAT) protocols. For example, as shown in FIG. 2, radio 230 may include a WLAN controller 250 configured to control WLAN communications, a short-range communication controller 252 configured to control short-range communications, and a WWAN controller 256 configured to control WWAN communications. In certain aspects, the wireless device 200 may store and execute a WLAN software driver for controlling WLAN operations performed by the WLAN controller 250, a short-range communication software driver for controlling short-range communication operations performed by the short-range communication controller 252, and/or a WWAN software driver for controlling WWAN operations performed by the WWAN controller 256.

In certain implementations, a first coexistence interface 254 (e.g., a wired interface) may be used for sending information between the WLAN controller 250 and the short-range communication controller 252. In certain other implementations, a second coexistence interface 258 may be used for sending information between the WLAN controller 250 and the WWAN controller 256. In certain other implementations, a third coexistence interface 260 may be used for sending information between the short-range communication controller 252 and the WWAN controller 256.

In some aspects, one or more of the WLAN controller 250, the short-range communication controller 252, and/or the WWAN controller 256 may be implemented as hardware, software, firmware or some combination thereof.

In certain configurations, the WLAN controller 250 may be configured to communicate with a second device in a WPAN using a WLAN link using all of the antennas 235a, 235b, 235c, 235d. In certain configurations, the short-range communication controller 252 may be configured to implement a BLE protocol stack (see FIG. 3), and communicate with at least one second device in a WPAN using one or more of the antennas 235a, 235b, 235c, 235d. In certain other configurations, the WWAN controller 256 may be configured to communicate with a second device in a WPAN using all of the antennas 235a, 235b, 235c, 235d. The short-range communication controller 252 may be configured to construct at least one PDU that is missing and/or failed to decode based on the redundancy error coding in decoded PDUs.

FIG. 3 illustrates a Bluetooth mesh network protocol stack 300 that may be implemented in a BLE device in accordance with certain aspects of the present disclosure. For example, the Bluetooth mesh network protocol stack 300 may be implemented by, e.g., one or more of processor(s) 202, memory 206, Flash memory 210, ROM 208, the radio 230, and/or the short-range communication controller 252 illustrated in FIG. 2.

Referring to FIG. 3, the Bluetooth mesh network protocol stack 300 may be configured to be utilized in conjunction with a BLE protocol stack, namely, the Link Layer 306 and the Physical Layer 308. Application block 302 may be a user application which interfaces with layers 304 of a BLE protocol stack and the Bluetooth mesh network protocol stack 300.

The Application block 302 may include higher-level Application Layers, and the Bluetooth mesh network protocol stack 300 may run under the Application Layer 302. The Bluetooth mesh network protocol stack 300 may use a Link Layer (LL) 306 and a Physical Layer (PHY) 308 of the BLE protocol stack.

The Bluetooth mesh network protocol stack 300 may comprise model layer 310, access layer 312, upper transport 314, lower transport 316, network layer 318, and bearer layer 320.

The model layer 310 may define models that may be used to standardize the operation of typical user scenarios and are defined in the Bluetooth mesh model specification or other higher layer specifications. Examples of higher layer model specifications include models for lighting and sensors. The model layer may also define the states, messages, and models required to configure and manage a mesh network.

The access layer 312 defines how higher layer applications may use the upper transport layer 314. The access layer 312 may define the format of the application data. The access layer 312 defines and controls the application data encryption and decryption performed in the upper transport layer 314. The access layer 312 may also check whether incoming application data has been received in the context of the right network and application keys before forwarding the incoming application data to the higher layer.

The upper transport layer 314 encrypts, decrypts, and authenticates application data and is designed to provide confidentiality of access messages. The upper transport layer may also define how transport control messages are used to manage the upper transport layer between nodes.

The lower transport layer 316 may define how upper transport layer messages are segmented and reassembled into multiple lower transport PDUs to deliver large upper transport layer messages to other nodes. The lower transport layer 316 may also define a single control message to manage segmentation and reassembly.

The network layer 318 may define how transport messages are addressed towards one or more elements. The network layer 318 may define the network message format that allows transport PDUs to be transported by a bearer layer 320. The network layer 318 decides whether to relay/forward messages, accept them for further processing, or reject them. The network layer 318 may also define how a network message is encrypted and authenticated.

The bearer layer 320 may define how network messages are transported between nodes. The bearer layer may comprise an advertising bearer layer (not shown) and an GATT bearer layer (not shown).

The PHY 308 may define the mechanism for transmitting a bit stream over a physical link that connects BLE devices. The bit stream may be grouped into code words or symbols, and converted to a PDU that is transmitted over a transmission medium. The PHY 308 may provide an electrical, mechanical, and procedural interface to the transmission medium. The shapes and properties of the electrical connectors, the frequency band used for transmission, the modulation scheme, and similar low-level parameters may be specified by the PHY 308.

The LL 306 may be responsible for low level communication over the PHY 308. The LL 306 may manage the sequence and timing of transmitted and received data packets, and using a LL protocol, communicate with other devices regarding connection parameters and data flow control. The LL 306 may provide gate keeping functionality to limit exposure and data exchange with other devices. If filtering is configured, the LL 306 may maintain a list of allowed devices and ignore all requests for data exchange from devices not on the list. The LL 306 may also reduce power consumption. The LL 306 may use the HCl (not shown in FIG. 3) to communicate with upper layers of the BLE protocol stack 300. The LL 306 may include a third party's proprietary LL that may be used to discover peer devices (e.g., other devices associated with the third party), and establish a secure communication channel therewith.

The BLE layers 304 may include and L2CAP (not shown) which may encapsulate multiple protocols from the upper layers into a data packet format (and vice versa). The L2CAP may also break packets with a large data payload from the upper layers into segments that fit into a maximum payload size (e.g., 27 bytes) on the transmit side. Similarly, the L2CAP may receive multiple data packets carrying a data payload that have been segmented, and the L2CAP may combine the segmented data payload into a single data packet carrying the data payload that may be sent to the upper layers.

The BLE layers 304 may also include an ATT (not shown) which may be a client/server protocol based on attributes associated with a BLE device configured for a particular purpose (e.g., monitoring heart rate, monitoring temperature, broadcasting advertisements, etc.). The BLE layers may also include a GATT (not shown) which describes a service framework using the attribute protocol for discovering services, and for reading and writing characteristic values on a peer device. The GATT interfaces with the App 302 through the App's profile. The App 302 profile defines the collection of attributes and any permission needed for the attributes to be used in BLE communications. One of the benefits of BT technology is device interoperability. To assure interoperability, using a standardized wireless protocol to transfer bytes of information may be inadequate, and hence, sharing data representation levels may be needed. In other words, BLE devices may send or receive data in the same format using the same data interpretation based on intended device functionality. The attribute profile used by the GATT may act as a bridge between the BLE protocol stack and the application and functionality of the BLE device (e.g., at least from a wireless connection point of view), and is defined by the profile.

The BLE layers may also include a GAP (not shown) which may provide an interface for the App 308 to initiate, establish, and manage connection with counterpart BLE devices.

Bluetooth mesh technology uses flood mesh where data packets are forwarded from node to node in a chaotic fashion. The data packets eventually reach the destination node, but may take various different pathways to reach the final destination. In Bluetooth mesh networks, all nodes may function as transmitters, relays, and receivers. The relay features allows a node the ability to receive and retransmit data packets to another node, which may extend the range of communication of the original message. Data packets making multiple hops between a transmitting (or re-transmitting) node and the destination node is allowed due to the relay feature.

A message path comprising multiple hops, as in Bluetooth mesh networks, has a combined probability of a packet being delivered successfully from the sender to the receiver. The overall probability being the product of the probabilities associated with each hop. This combined probability will reduce in proportion to the number of hops. There are many types of data, such as but not limited to a firmware update image, where it is crucial that the original object is reassembled without errors and in its entirety.

Where a large data object is fragmented into many pieces for the purpose of transmission via a network that uses an unreliable system of transmission (e.g., using multiple hops), there is typically a high probability that one or more fragments will fail to be delivered to the receiver successfully. The receiver needs to be able to recreate the original data object accurately even if some of the fragments are corrupted or not received at all.

Thus, there exists a need for a receiver (e.g., node) in an unreliable packet network (e.g., a Bluetooth mesh network) to be able to recreate the original data object accurately in instances where some of the fragments received are missing or failed to decode.

The present disclosure provides an error correction technique whereby data objects may be processed prior to transmission to add error correction coding to each fragment, such that missing and/or fragments that failed to decode (e.g., corrupted fragments) may be reconstructed based on the error correction data of decoded fragments. The error correction technique may be configured to recover the missing and/or corrupted fragments in instances where sufficient fragments have been received and decoded, such that the entire data object may be properly reconstructed.

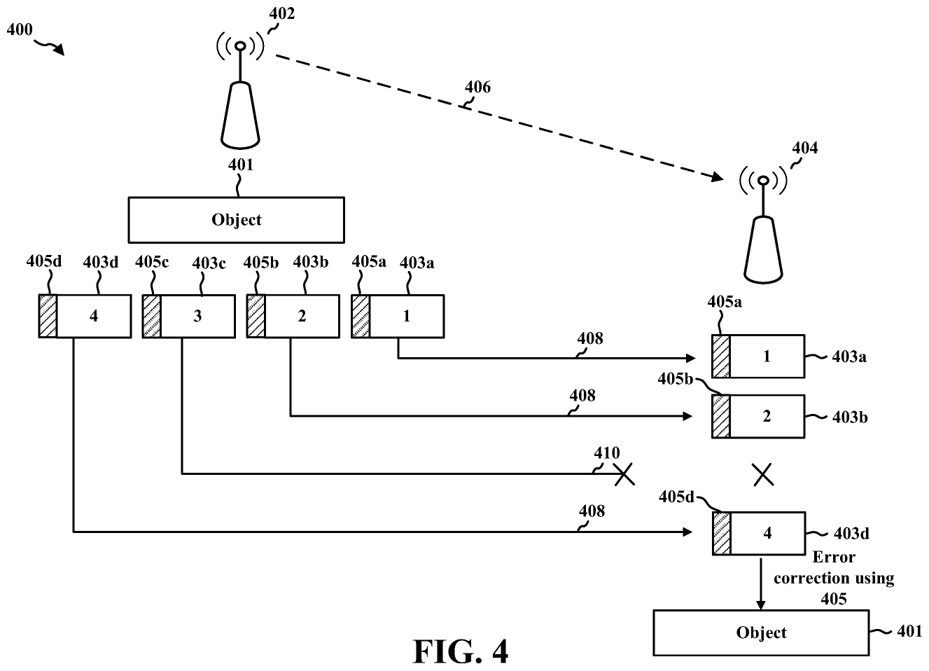

FIG. 4 illustrates a diagram 400 of wireless communications in accordance with certain aspects of the disclosure. In diagram 400, the wireless communication may be between a first node 402 and a second node 404 in a wireless network (e.g., Bluetooth mesh network). First node 402 may correspond to, e.g., devices 102, 104, 106, 108, 110, 112, 114, wireless device 200, the apparatus 702/702′ or the mesh node 750. Second node 404 may correspond to, e.g., devices 102, 104, 106, 108, 110, 112, 114, wireless device 200 the apparatus 702/702′ or the mesh node 750.

As seen in FIG. 4, the first node 402 (e.g., transmitting node) may transmit a message (e.g., object 401) to the second node 404 via a wireless communication link 406 in a wireless network, such as but not limited to a Bluetooth mesh network. The first node 402, in preparation of transmitting the message to the second node 404, may be configured to process the message to include an error correction coding. The error correction coding allows the second node 404 to recreate the original message (e.g., object 401) in instances where portions or fragments of the original message are missing or failed to decode. In some aspects, the first node 402 may be configured to code the message based on a redundancy error code. In some aspects, the first node 402 may be configured to code the message using many different types of error correction techniques and the disclosure is not intended to be limited to redundancy error code. In yet some aspects, the first node 402 may be configured to code the object utilizing the Reed Solomon algorithm or a RAIDS style of data recovery as used in personal computers and servers.

The first node 402 may be configured to split the message (e.g., object 401) into a plurality of packet data units (PDUs) 403a-403d. In some aspects, each of the PDUs (e.g., 403a-403d) may have a sequence number and a corresponding portion of the redundancy error coding (e.g., 405a-405d). The sequence number provides an indication to the receiving node (e.g., second node 404) with regard to the positioning of the received segment within the sequence of segments, and the total number of segments. The redundancy error coding portions (e.g., 405a-405d) may include different portions of the redundancy error coding, such that the portions are not identical in terms of the data content they represent. The redundancy error coding portions 405a-405d are depicted in FIG. 4 as being at an end of the respective PDU 403a-403d, but this is a symbolic representation of the structuring of the redundancy error coding portions. The structuring of the redundancy error coding portions is not intended to be limited to the aspect as shown in FIG. 4. The redundancy error coding portions may be structured in many different configurations, such as but not limited to, the coding being applied across all bits in the PDUs or may be interleaved across the whole PDU. In some aspects, the redundancy error coding operation may occur after the object 401 has been split into the plurality of PDUs. The first node 402 may be further configured to segment each of the PDUs 403a-403d into a plurality of segmented messages. In some aspects, a lower transport layer of the first node 402 may define how the message may be segmented into the plurality of PDUs 403a-403d in order for the message to be transmitted to at least the second node 404. The first node 402 may be configured to broadcast the segmented messages to one or more nodes (e.g., second node 404).

In some aspects, the first and second nodes 402, 404 may be within a Bluetooth mesh network which may include additional nodes beyond the first and second nodes. In such instances, the first node 402 may be configured to broadcast one or more of the plurality of segmented messages to the second node 404 via one or more of the additional nodes. For example, the first node 402 may broadcast one or more of the plurality of segmented messages to a third node (not shown), such that the third node receives the one or more of the plurality of segmented messages and forwards the one or more of the plurality of segmented messages to the second node 404. In such instance, the third node is acting as a relay node which takes advantage of the relay feature to allow the third node the ability to receive and retransmit the one or more of the plurality of segmented messages to the second node 404. In some aspects, the first node 402 may not have a direct link to the second node 404, but the object 401 is destined to be received at the second node 404. In such instances, the first node 402 may have a direct link to at least the third node (or neighbor node). The third node may have a link to the second node 404 or a link to another node that may have a link to the second node, such that the message (e.g., object 401) may take one or more hops through one or more nodes to reach the final destination of the second node 404. In yet some aspects, the first node 402 may broadcast the one or more of the plurality of segmented messages to multiple neighbor nodes which may then forward the one or more of the plurality of segmented messages towards the second node 404 or to one or more of its neighbor nodes which may then forward the one or more of the plurality of segmented messages towards the second node 404. The aspect of FIG. 4 includes the first and second node 402, 404, but the disclosure is not intended to be limited to only have the first and second node 402, 404. As discussed herein, there can be one or more nodes between the first and second node 402, 404, such that the second node 404 may receive the plurality of broadcasted segmented messages via different paths in a mesh network from the one or more nodes.

With reference to FIG. 4, the object 401 has been processed to include the redundancy error code and split into the plurality of PDUs 403a-403d, with each PDU having a corresponding portion of the redundancy error code 405a-d. The first node 402 transmits the first PDU 403a to the second node 404 along path 408, and the first PDU 403a is successfully received and decoded at the second node 404. The first node 402 then transmits the second PDU 403b to the second node 404 along path 408, and the second PDU 403b is also successfully received and decoded at the second node 404. The first node then transmits the third PDU 403c to the second node along path 410, but the third PDU 403c may be corrupted when received by the second node and could not be decoded. In some aspects, errors may have been introduced to the third PDU 403c during transmission that prevented the second node 404 from properly decoding the third PDU 403c. In some aspects, an error may have occurred to the path 410 during transmission of the third PDU 403c, such that the third PDU 403c was never received by the second node 404. In such instance, the third PDU 403c may be considered as a missing fragment. The first node 402 may or may not attempt to retransmit the third PDU 403c, but may move on to transmit the remaining PDUs (e.g., PDU 403d). As shown in FIG. 4, the fourth PDU 403d is successfully received and decoded by the second node 404.

In instances where one or more PDUs are missing or were not properly decoded by the destination node (e.g., second node 404), the destination node (e.g., second node 404) may be configured to reconstruct the corrupted and/or missing segments provided that it has received enough segments containing the redundancy error code.

In the aspect of FIG. 4, the second node 404 is the destination node. The second node 404 may be configured to receive the plurality of broadcasted segmented messages from one or more nodes (e.g., first node 402). In some aspects, each of the segmented messages includes the redundancy error coding. The second node may be configured to reassemble the segmented messages into a plurality of PDUs. In some aspects, each PDU of the plurality of PDUs may have a sequence number. The second node may be configured to keep a record of the received PDUs based on sequence number, such that any duplicate PDUs received by the second node may be ignored or discarded. The second node may be further configured to determine whether one or more of the PDUs failed to decode or whether one or more of the PDUs are missing. In some aspects, the second node may determine that a particular PDU failed to decode upon attempting to decode the particular PDU. In some aspects, in order to determine that one or more PDUs failed to decode, the second node may be configured to determine whether the one or more PDUs are corrupted. Failure to decode the PDU may be due to many reasons, such as but not limited to, errors being introduced into the PDU during transit. In some aspects, a PDU may not be received by the second node because an error occurred to the transmission link such that the PDU was unable to reach its final destination (e.g., second node). The second node may also determine whether any PDUs are missing based on the sequence number.

The second node may be configured to construct at least one PDU (e.g., missing or failed to decode PDU) of the one or more PDUs based on the redundancy error code 405a, b, d in decoded PDUs (e.g., 403a, 403b, 403d). The second node may be configured to utilize the information within the redundancy error code 405a, b, d received within each of the successfully received and decoded PDUs to construct the at least one PDU (e.g., missing or failed to decode PDU). Since the at least one PDU (e.g., 403c) is missing or failed to decode, the second node does not have the redundancy error code 405c associated with the missing or failed to decode PDU 403c, such that reconstructing the missing or failed to decode PDU 403c is done without the corresponding redundancy error code 405c. In some aspects, to construct the at least one PDU based on the redundancy error coding in the decoded PDUs, the second node may be configured to reconstruct the at least one PDU (e.g., 403c) based on the redundancy error coding in the decoded PDUs (e.g., 403a, 403b, 403d). The inclusion of the redundancy error code to each PDU allows the second node to reconstruct missing and/or corrupted PDUs, provided that sufficient PDUs are received and decoded. In some aspects, the at least one PDU (e.g., missing or failed to decode) may be constructed based on the redundancy error coding in the decoded PDUs when a number of the decoded PDUs is greater than a threshold amount.

After reconstructing the at least one PDU (e.g., missing or failed to decode PDU) based on the redundancy error coding within the decoded PDUs, the second node 404 may be further configured to reassemble the PDUs into an object (e.g., object 401) based on the sequence number for each PDU. In some aspects, a lower transport layer of the second node 404 may be configured to reassembly the plurality of PDUs, along with any reconstructed PDUs, into the object (e.g., object 401). The redundancy error code allows the second node to reconstruct the information within the missing or corrupted PDU, which allows the second node to properly reassemble the original message (e.g., object 401). In some aspects, the second node may reassemble the plurality of PDUs based on the sequence numbers. At least one advantage of the disclosure is that the destination node may utilize the redundancy error coding to reconstruct missing and/or corrupted PDUs, which eliminates the need for the destination node to request retransmission of the entire original message. In aspects utilizing a Bluetooth mesh network, having each destination node request a retransmission of the original message may lead to inefficiencies and/or congestion issues, especially if there are numerous destination nodes requesting retransmissions. Yet another advantage is that the disclosure allows for large object files to be sent via the Bluetooth mesh network. The large object file (e.g., firmware update image) may be distributed to one or more of the plurality of nodes in the mesh network, and it is crucial that a firmware update image be properly received by the nodes otherwise the node may not install the update image. The disclosure would allow for any portion of the update image to be reconstructed, as needed, to ensure that the update image is properly reassembled.

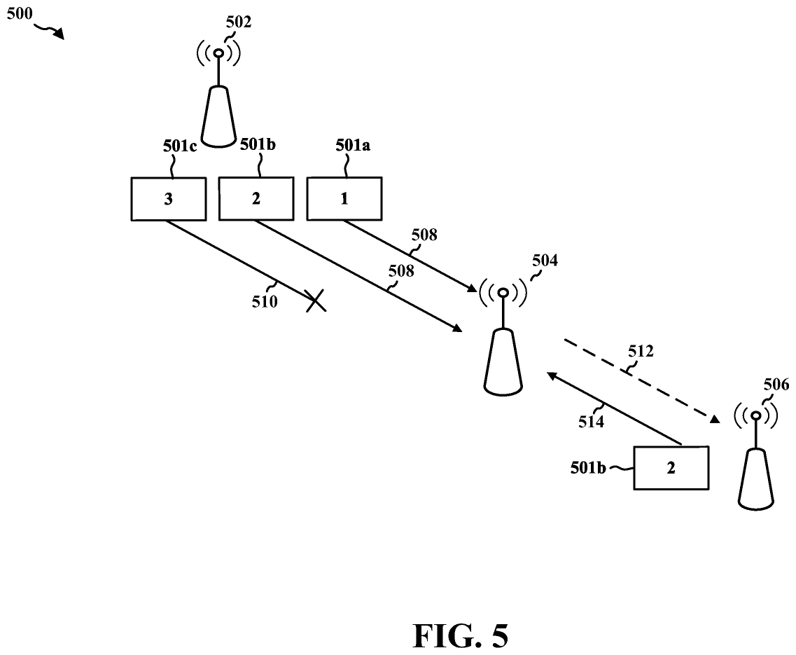

FIG. 5 illustrates a diagram 500 of wireless communications in accordance with certain aspects of the disclosure. In diagram 500, the wireless communication may be between a first node 502, a second node 504, and a third node 506 in a wireless network (e.g., Bluetooth mesh network). First node 502 may correspond to, e.g., devices 102, 104, 106, 108, 110, 112, 114, wireless device 200, the apparatus 702/702′ or the mesh node 750. Second node 504 may correspond to, e.g., devices 102, 104, 106, 108, 110, 112, 114, wireless device 200 the apparatus 702/702′ or the mesh node 750. Third node 506 may correspond to, e.g., devices 102, 104, 106, 108, 110, 112, 114, wireless device 200 the apparatus 702/702′ or the mesh node 750.

The aspect of FIG. 5 may be configured in a manner similar to the aspect disclosed in FIG. 4. The first node 502 may be configured similarly to the first node 402. The first node 502 may be configured to code an object (not shown) to include a redundancy error code, as discussed above, and may be further configured to split the object into a plurality of PDUs, segment each of the PDUs into a plurality of segmented messages, and broadcast the segmented messages to one or more nodes (e.g., second node 504).

As shown in FIG. 5, the first node 502 may transmit the first PDU 501a and the second PDU 501b to the second node 504 along path 508, with both the first and second PDUs 501a, 501b being successfully received and decoded by the second node 504. The first node 502 may also transmit the third PDU 501c along path 510, but the third PDU 501c may encounter issues during transmission such that the second node 504 is unable to decode the third PDU 501c, or the third PDU 501c does not reach the second node 504 and is not received by the second node 504. In such instances, the second node 504 may be configured to request a retransmission of one or more PDUs, other than the at least one PDU (e.g., missing or failed to decode) from at least one node (e.g., third node 506) of the one or more nodes. For example, the second node 504 may send a retransmission request 512 to the third node 506, requesting the third node 506 to retransmit one or more PDUs (e.g., 501b) other than the at least one missing or failed to decode PDU (e.g., 501c). The third node 506 re-transmits PDU 501b to the second node 504 along path 514, whereby the re-transmitted PDU 501b is properly received and decoded by the second node 504. The second node 504 may then be configured to construct the at least one PDU (e.g., PDU 501c) based on PDUs retransmitted from the at least one node (e.g., third node 506) combined with PDUs already received. The second node 504 may be configured to utilize the redundancy error code of the received PDUs and the retransmitted PDUs to construct the at least one PDU (e.g., PDU 501c), whereby the second node 504 may reassemble the PDUs into the original object. At least one advantage of the disclosure is that the second node 504 may request re-transmission of one or more missing fragments from nearby mesh nodes that possess some fragments of the object, rather than requiring the original source to re-send the data, even if none of the nearby nodes possesses the entire object itself. The aspect of FIG. 5 discloses three nodes 502, 504, 506, but the disclosure is not intended to be limited to the aspects disclosed herein. In some aspects, there can be one or more nodes between each of the first, second, and/or third nodes 502, 504, 506. Furthermore, although node 502 is described as the first node, the label of such node as the first node serves the purpose to identify a node with respect to other nodes, and is not intended to imply that the first node 502 is the source or original broadcasting node of a mesh network. As discussed above, in Bluetooth mesh networks, nodes may function as relays, wherein the relay feature allows a node the ability to receive and retransmit data packets to another node, which may extend the range of communication of the original message. Thus, in some aspects, the first node 502 may be relaying a data packets to another node, received from a different node, such that the first node 502 is not the original broadcasting node of the data packets.

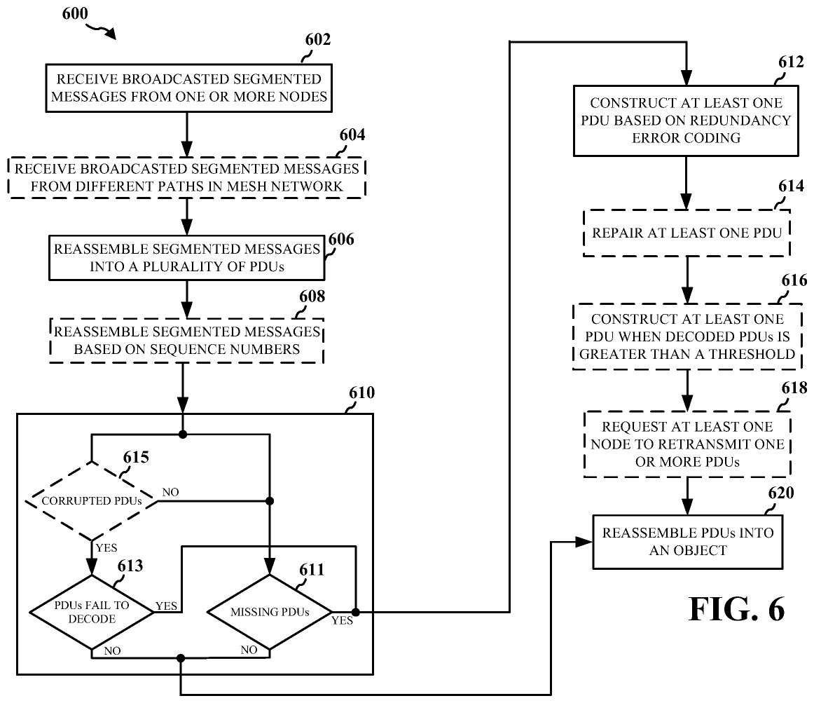

FIG. 6 is a flowchart 600 of a method of wireless communication. The method may be performed by a first device (e.g., devices 102, 104, 106, 108, 110, 112, 114, wireless device 200, the apparatus 702/702′) in communication with a second device (e.g., devices 102, 104, 106, 108, 110, 112, 114, wireless device 200, the apparatus 702/702′). In FIG. 6, optional operations are indicated with dashed lines.

Referring to FIG. 6, at 602, the first device (e.g., node 404, 504) may be configured to receive a plurality of broadcasted segmented messages from one or more nodes (e.g., node 402, 502, 506), as discussed in reference to FIGS. 4 and 5. In some aspects, each segmented message of the segmented messages may include redundancy error coding (e.g., redundancy error code 405a-d). In some aspects, for example, at 604, the first device (e.g., node 404, 504) may be configured to receive the plurality of broadcasted segmented messages via different paths in a mesh network from the one or more nodes. At 606, the first device (e.g., node 404, 504) may be configured to reassemble the segmented messages into a plurality of PDUs (e.g., 403a-d and 501a-c). In some aspects, each PDU of the plurality of PDUs has a sequence number. In some aspects, for example, at 608, the segmented messages may be reassembled into the plurality of PDUs (e.g., 403a-d and 501a-c) based on the sequence numbers. At 610, the first device (e.g., node 404, 504) may be configured to determine, at 613, whether one or more PDUs (e.g., PDU 403c, 501c) of the plurality of PDUs failed to decode upon attempting to decode each of the PDUs. The first device (e.g., node 404, 504) may be configured to determine, at 611, whether one or more PDUs (e.g., PDU 403c, 501c) are missing from the plurality of PDUs based on the sequence number, as discussed in combination with FIGS. 4 and 5. In some aspects, to determine that one or more PDUs (e.g., PDU 403c, 501c) of the plurality of PDUs failed to decode, the first device (e.g., node 404, 504) may be configured to determine, at 615, whether one or more PDUs (e.g., PDU 403c, 501c) may be corrupted. At 612, the first device (e.g., node 404, 504) may be configured to construct at least one PDU (e.g., PDU 403c, 501c) of the one or more PDUs based on the redundancy error coding (e.g., 405a, b, d) in decoded PDUs (e.g., PDUs 403a, 403b, 403d, 501a, 501b) other than the at least one PDU (e.g., PDU 403c, 501c). In some aspects, for example, at 614, to construct the at least one PDU (e.g., PDU 403c, 501c) based on the redundancy error coding in the decoded PDUs (e.g., PDUs 403a, 403b, 403d, 501a, 501b), the first device (e.g., node 404, 504) may be configured to reconstruct the at least one PDU (e.g., PDU 403c, 501c) based on the redundancy error coding (e.g., 405a, b, d) in the decoded PDUs (e.g., PDUs 403a, 403b, 403d, 501a, 501b). In some aspects, for example, at 616, the at least one PDU (e.g., PDU 403c, 501c) may be constructed based on the redundancy error coding in the decoded PDUs (e.g., 403a, 403b, 403d, 501a, 501b) when a number of the decoded PDUs is greater than a threshold.

At 618, the first device (e.g., node 504) may be configured to request (e.g., retransmission request 512) at least one node (e.g., node 506) of the one or more nodes to retransmit one or more PDUs (e.g., PDU 501b) other than the at least one PDU (e.g., PDU 501c). In some aspects, the at least one PDU (e.g., PDU 501c) may be constructed based on PDUs (e.g., PDU 501b) retransmitted from the at least one node (e.g., node 506) combined with PDUs (e.g., PDU 501a, 501b) already received. Finally, at 620, the first device may be configured to reassemble the PDUs (e.g., PDUs 403a-d, 501a-c) into an object (e.g., object 401) based on the sequence number for each PDU.

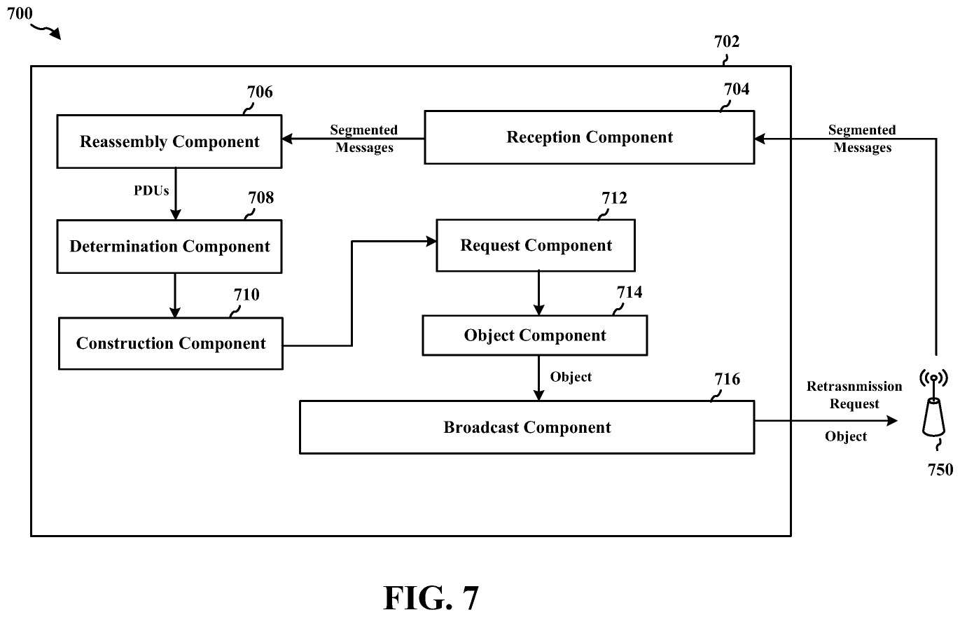

FIG. 7 is a conceptual data flow diagram 700 illustrating the data flow between different means/components in an exemplary apparatus 702. The apparatus may be a first device (e.g., central device 102, peripheral device 104, 106, 108, 110, 112, 114, wireless device 200, the apparatus 1002′) in communication with a second device (e.g., central device 102, peripheral device 104, 106, 108, 110, 112, 114, wireless device 200, the apparatus 1002′). The apparatus includes a reception component 704, a reassembly component 706, a determination component 708, a construction component 710, a request component 712, an object component 714, and a broadcast component 716.

The reception component 704 may be configured to receive a plurality of broadcasted segmented messages from one or more nodes (e.g., nodes 402, 502, 506, 750). In some aspects, each segmented message of the segmented messages may include redundancy error coding (e.g., redundancy error code 405a-d), as discussed in combination with FIGS. 4 and 5. In some aspects, the reception component 704 may receive the plurality of broadcasted segmented messages via different paths in a mesh network from the one or more nodes (e.g., nodes 402, 502, 506).

The reassembly component 706 may be configured to reassemble the segmented messages into a plurality of PDUs (e.g., PDUs 403a-d and 501a-c). In some aspects, each PDU of the plurality of PDUs has a sequence number. In some aspects, the segmented messages may be reassembled into the plurality of PDUs based on the sequence numbers. The determination component 708 may be configured to determine whether one or more PDUs (e.g., PDU 403c, 501c) of the plurality of PDUs has failed to decode upon an attempt to decode each of the PDUs. The determination component 708 may be configured to determine whether one or more PDUs (e.g., PDU 403c, 501c) are missing from the plurality of PDUs based on the sequence number. In some aspects, to determine whether one or more PDUs (e.g., PDU 403c, 501c) of the plurality of PDUs failed to decode, the determination component 708 may be configured to determine whether one or more PDUs (e.g., PDU 403c, 501c) may be corrupted.

The construction component 710 may be configured to construct at least one PDU (e.g., PDU 403c, 501c) of the one or more PDUs based on the redundancy error coding (e.g., 405a, b, d) in decoded PDUs (e.g., PDUs 403a, 403b, 403d, 501a, 501b) other than the at least one PDU (e.g., PDU 403c, 501c). In some aspects, to construct the at least one PDU (e.g., PDU 403c, 501c) based on the redundancy error coding (e.g., 405a, b, d) in the decoded PDUs (e.g., PDUs 403a, 403b, 403d, 501a, 501b), the construction component 710 may be configured to reconstruct the at least one PDU (e.g., PDU 403c, 501c) based on the redundancy error coding (e.g., 405a, b, d) in the decoded PDUs (e.g., PDUs 403a, 403b, 403d, 501a, 501b). In some aspects, the at least one PDU (e.g., PDU 403c, 501c) may be constructed based on the redundancy error coding (e.g., 405a, b, d) in the decoded PDUs (e.g., 403a, 403b, 403d, 501a, 501b) when a number of the decoded PDUs is greater than a threshold.

The request component 712 may be configured to request (e.g., retransmission request 512) at least one node (e.g., node 506) of the one or more nodes to retransmit one or more PDUs (e.g., PDU 501b) other than the at least one PDU (e.g., PDU 501c). In some aspects, the at least one PDU (e.g., PDU 501c) may be constructed based on PDUs (e.g., PDU 501b) retransmitted from the at least one node (e.g., node 506) combined with PDUs (e.g., PDUs 501a, 501b) already received. The object component 714 may be configured to reassemble the PDUs (e.g., PDUs 403a-d, 501a-c) into an object (e.g., object 401) based on the sequence number for each PDU.

The apparatus may include additional components that perform each of the blocks of the algorithm in the aforementioned flowchart of FIG. 6. As such, each block in the aforementioned flowchart of FIG. 6 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

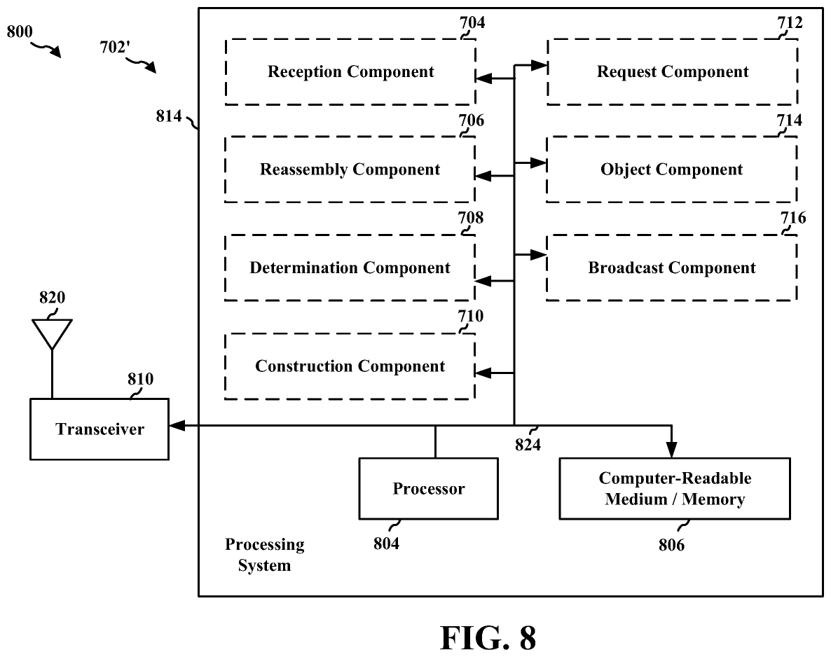

FIG. 8 is a diagram 800 illustrating an example of a hardware implementation for an apparatus 702′ employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware components, represented by the processor 804, the components 704, 706, 708, 710, 712, 714, 716 and the computer-readable medium/memory 806. The bus 824 may also link various other circuits such as timing sources, peripherals, voltage regulators, and power management circuits, which are well known in the art, and therefore, will not be described any further.

The processing system 814 may be coupled to a transceiver 810. The transceiver 810 is coupled to one or more antennas 820. The transceiver 810 provides a means for communicating with various other apparatus over a transmission medium. The transceiver 810 receives a signal from the one or more antennas 820, extracts information from the received signal, and provides the extracted information to the processing system 814, specifically the reception component 704. In addition, the transceiver 810 receives information from the processing system 814, specifically the broadcast component 716, and based on the received information, generates a signal to be applied to the one or more antennas 820. The processing system 814 includes a processor 804 coupled to a computer-readable medium/memory 806. The processor 804 is responsible for general processing, including the execution of software stored on the computer-readable medium/memory 806. The software, when executed by the processor 804, causes the processing system 814 to perform the various functions described supra for any particular apparatus. The computer-readable medium/memory 806 may also be used for storing data that is manipulated by the processor 804 when executing software. The processing system 814 further includes at least one of the components 704, 706, 708, 710, 712, 714, and 716. The components may be software components running in the processor 804, resident/stored in the computer readable medium/memory 806, one or more hardware components coupled to the processor 804, or some combination thereof.

In certain configurations, the apparatus 702/702′ for wireless communication may include means for receiving a plurality of broadcasted segmented messages from one or more nodes. Each segmented message of the segmented messages may include redundancy error coding. The apparatus 702/702′ may include means for reassembling the segmented messages into a plurality of PDUs. Each PDU of the plurality of PDUs having a sequence number. The apparatus 702/702′ may include means for determining that one or more PDUs of the plurality of PDUs failed to decode upon attempting to decode each of the PDUs, or that the one or more PDUs are missing from the plurality of PDUs based on the sequence number. The apparatus 702/702′ may include means for constructing at least one PDU of the one or more PDUs based on the redundancy error coding in decoded PDUs other than the at least one PDU. The apparatus 702/702′ may include means for reassembling the PDUs into an object based on the sequence number for each PDU. The apparatus 702/702′ may further include means for determining that one or more PDUs are corrupted. The apparatus 702/702′ may further include means for reconstructing the at least one PDU based on the redundancy error coding in the decoded PDUs. The apparatus 702/702′ may further include means for requesting at least one node of the one or more nodes to retransmit one or more PDUs other than the at least one PDU. At least one PDU may be constructed based on PDUs retransmitted from the at least one node combined with PDUs already received. The aforementioned means may be the processor(s) 202, the radio 230, the MMU 240, the WLAN controller 250/short-range communication controller 252/the WWAN controller 256, one or more of the aforementioned components of the apparatus 702 and/or the processing system 814 of the apparatus 702′ configured to perform the functions recited by the aforementioned means.

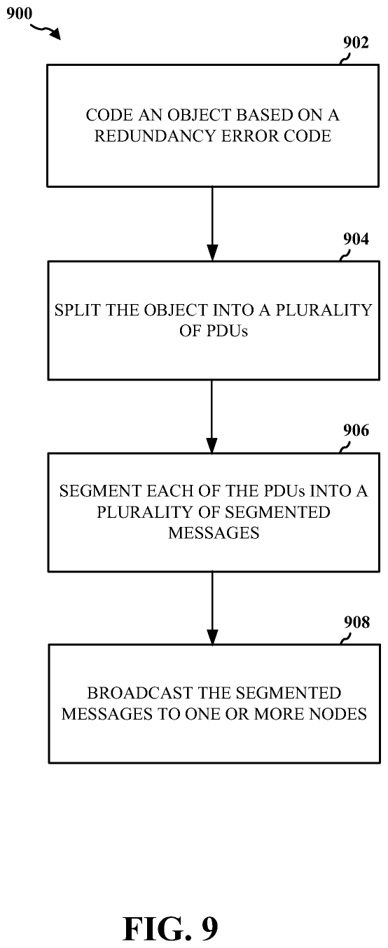

FIG. 9 is a flowchart 900 of a method of wireless communication. The method may be performed by a first device (e.g., the central device 102, peripheral device 104, 106, 108, 110, 112, 114, wireless device 200, the apparatus 1002/1002′) in communication with a second device (e.g., central device 102, peripheral device 104, 106, 108, 110, 112, 114, wireless device 200, the apparatus 1002/1002′). In FIG. 9, optional operations are indicated with dashed lines.

Referring to FIG. 9, at 902, the first device (e.g., node 402, 502) may be configured to code an object (e.g., object 401) based on a redundancy error code (e.g., redundancy error code 405a-d), as discussed in reference to FIGS. 4 and 5. At 904, the first device (e.g., node 402, 502) may be configured to split the object 401 into a plurality of PDUs (e.g., 403a-d, 501a-c). In some aspects, as discussed in reference to FIGS. 4 and 5, each of the PDUs may have a sequence number and a corresponding portion of the redundancy error code (e.g., redundancy error code 405a-d). In some aspects, the first device may be configured to perform the redundancy error coding operation after the object 401 has been split into the plurality of PDUs. At 906, the first device (e.g., node 402, 502) may be configured to segment each of the PDUs (e.g., 403a-d, and 501a-c) into a plurality of segmented messages. At 908, the first device (e.g., node 402, 502) may be configured to broadcast the segmented messages to one or more nodes (e.g., node 404, 504). In some aspects, the segmented messages may be broadcasted by the node (e.g., node 402, 502) to a second node (e.g., node 404, 504) via the one or more nodes.

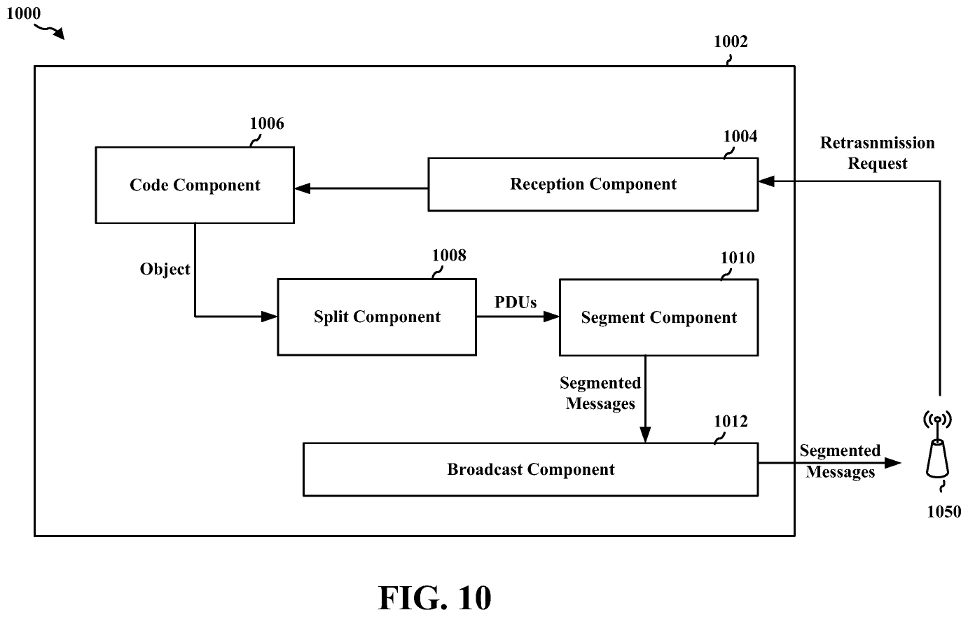

FIG. 10 is a conceptual data flow diagram 1000 illustrating the data flow between different means/components in an exemplary apparatus 1002. The apparatus may be a first device (e.g., central device 102, peripheral device 104, 106, 108, 110, 112, 114, wireless device 200, the apparatus 1002′) in communication with a second device (e.g., central device 102, peripheral device 104, 106, 108, 110, 112, 114, wireless device 200, the apparatus 1002′). The apparatus includes a reception component 1004, a code component 1006, a split component 1008, a segment component 1012, and a broadcast component 1014.

The reception component 1004, may be configured to receive a signal from a node 1050. In some aspects, the signal may be a retransmission request (e.g., retransmission request 512) as discussed in FIG. 5. The reception component 1004, may be configured to provide an object (e.g., object 401) to the code component 1006 for further processing. The code component 1006, may be configured to code the object (e.g., object 401) based on a redundancy error code (e.g., redundancy error code 405a-d).

The split component 1008, may be configured to split the object (e.g., object 401) into a plurality of PDUs (e.g., 403a-d and 501a-c). In some aspects, each of the PDUs may have a sequence number and a corresponding portion of the redundancy error code (e.g., redundancy error code 405a-d). The segment component 1010 may be configured to segment each of the PDUs (e.g., 403a-d and 501a-c) into a plurality of segmented messages, as discussed in reference to FIGS. 4 and 5. In some aspects, the code component 1006 may come after the split component 1008, such that the redundancy error coding operations of the code component 1006 may be performed after the split component 1008 splits the object into the plurality of PDUs. The broadcast component 1012 may be configured to broadcast (e.g., 408, 410, 508, 510, and 514) the segmented messages to one or more nodes (e.g., nodes 404, 504). In some aspects, the segmented messages may be broadcasted by the node (e.g., node 402, 502, 506) to one or more nodes (e.g., node 404, 504) via one or more nodes, as discussed in reference to FIGS. 4 and 5.

The apparatus may include additional components that perform each of the blocks of the algorithm in the aforementioned flowchart of FIG. 9. As such, each block in the aforementioned flowchart of FIG. 9 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

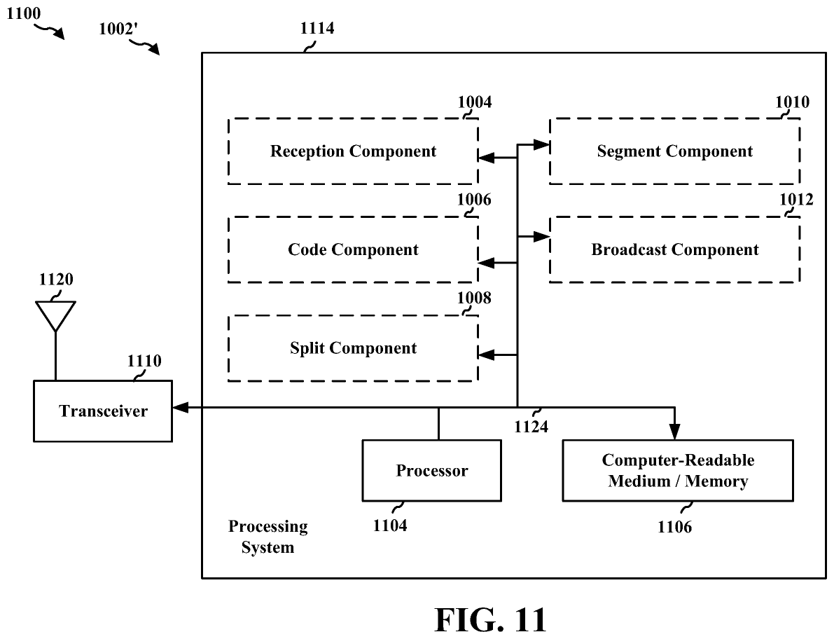

FIG. 11 is a diagram 1100 illustrating an example of a hardware implementation for an apparatus 1002′ employing a processing system 1114. The processing system 1114 may be implemented with a bus architecture, represented generally by the bus 1124. The bus 1124 may include any number of interconnecting buses and bridges depending on the specific application of the processing system 1114 and the overall design constraints. The bus 1124 links together various circuits including one or more processors and/or hardware components, represented by the processor 1104, the components 1004, 1006, 1008, 1010, 1012 and the computer-readable medium/memory 1106. The bus 1124 may also link various other circuits such as timing sources, peripherals, voltage regulators, and power management circuits, which are well known in the art, and therefore, will not be described any further.

The processing system 1114 may be coupled to a transceiver 1110. The transceiver 1110 is coupled to one or more antennas 1120. The transceiver 1110 provides a means for communicating with various other apparatus over a transmission medium. The transceiver 1110 receives a signal from the one or more antennas 1120, extracts information from the received signal, and provides the extracted information to the processing system 1114, specifically the reception component 1004. In addition, the transceiver 1110 receives information from the processing system 1114, specifically the broadcast component 1012, and based on the received information, generates a signal to be applied to the one or more antennas 1120. The processing system 1114 includes a processor 1104 coupled to a computer-readable medium/memory 1106. The processor 1104 is responsible for general processing, including the execution of software stored on the computer-readable medium/memory 1106. The software, when executed by the processor 1104, causes the processing system 1114 to perform the various functions described supra for any particular apparatus. The computer-readable medium/memory 1106 may also be used for storing data that is manipulated by the processor 1104 when executing software. The processing system 1114 further includes at least one of the components 1004, 1006, 1008, 1010, and 1012. The components may be software components running in the processor 1104, resident/stored in the computer readable medium/memory 1106, one or more hardware components coupled to the processor 1104, or some combination thereof.

In certain configurations, the apparatus 1002/1002′ for wireless communication may include means for coding an object based on a redundancy error code, means for splitting the object into a plurality of PDUs, each of the PDUs having a sequence number and a corresponding portion of the redundancy error code, means for segmenting each of the PDUs into a plurality of segmented messages, and means for broadcasting the segmented messages to one or more nodes. The aforementioned means may be the processor(s) 202, the radio 230, the MMU 240, the WLAN controller 250/short-range communication controller 252/the WWAN controller 256, one or more of the aforementioned components of the apparatus 1002 and/or the processing system 1114 of the apparatus 1002′ configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a wireless communication device at a node, comprising:
receiving a plurality of broadcasted segmented messages from one or more nodes, each segmented message of the segmented messages including redundancy error coding;
reassembling the segmented messages into a plurality of packet data units (PDUs), each PDU of the plurality of PDUs having a sequence number;
determining that one or more PDUs of the plurality of PDUs failed to decode upon attempting to decode each of the PDUs, or that the one or more PDUs are missing from the plurality of PDUs based on the sequence number;
constructing at least one PDU of the one or more PDUs based on the redundancy error coding in decoded PDUs other than the at least one PDU; and
reassembling the PDUs into an object based on the sequence number for each PDU.

2. The method of claim 1, wherein the determining that one or more PDUs of the plurality of PDUs failed to decode comprises determining that one or more PDUs are corrupted, and the constructing the at least one PDU based on the redundancy error coding in the decoded PDUs comprises reconstructing the at least one PDU based on the redundancy error coding in the decoded PDUs.

3. The method of claim 1, wherein the wireless communication device receives the plurality of broadcasted segmented messages via different paths in a mesh network from the one or more nodes.

4. The method of claim 1, wherein the segmented messages are reassembled into the plurality of PDUs based on the sequence numbers.

5. The method of claim 1, wherein the at least one PDU is constructed based on the redundancy error coding in the decoded PDUs when a number of the decoded PDUs is greater than a threshold.

6. The method of claim 1, further comprising requesting at least one node of the one or more nodes to retransmit one or more PDUs other than the at least one PDU, wherein the at least one PDU is constructed based on PDUs retransmitted from the at least one node combined with PDUs already received.

7. A method of wireless communication of a wireless communication device at a node, comprising:
coding an object based on a redundancy error code;
splitting the object into a plurality of packet data units (PDUs), each of the PDUs having a sequence number and a corresponding portion of the redundancy error code;
segmenting each of the PDUs into a plurality of segmented messages; and
broadcasting the segmented messages to one or more nodes.

8. The method of claim 7, wherein the segmented messages are broadcasted by the node to a second node via the one or more nodes.

9. An apparatus for wireless communication, comprising:
means for receiving a plurality of broadcasted segmented messages from one or more nodes, each segmented message of the segmented messages including redundancy error coding;
means for reassembling the segmented messages into a plurality of packet data units (PDUs), each PDU of the plurality of PDUs having a sequence number;
means for determining that one or more PDUs of the plurality of PDUs failed to decode upon attempting to decode each of the PDUs, or that the one or more PDUs are missing from the plurality of PDUs based on the sequence number;
means for constructing at least one PDU of the one or more PDUs based on the redundancy error coding in decoded PDUs other than the at least one PDU; and
means for reassembling the PDUs into an object based on the sequence number for each PDU.

10. The apparatus of claim 9, wherein the means for determining that one or more PDUs of the plurality of PDUs failed to decode comprises means for determining that one or more PDUs are corrupted, and the means for constructing the at least one PDU based on the redundancy error coding in the decoded PDUs comprises means for reconstructing the at least one PDU based on the redundancy error coding in the decoded PDUs.

11. The apparatus of claim 9, wherein the apparatus receives the plurality of broadcasted segmented messages via different paths in a mesh network from the one or more nodes.

12. The apparatus of claim 9, wherein the segmented messages are reassembled into the plurality of PDUs based on the sequence numbers.

13. The apparatus of claim 9, wherein the at least one PDU is constructed based on the redundancy error coding in the decoded PDUs when a number of the decoded PDUs is greater than a threshold.

14. The apparatus of claim 9, further comprising means for requesting at least one node of the one or more nodes to retransmit one or more PDUs other than the at least one PDU, wherein the at least one PDU is constructed based on PDUs retransmitted from the at least one node combined with PDUs already received.

15. An apparatus for wireless communication at a node, comprising:
means for coding an object based on a redundancy error code;
means for splitting the object into a plurality of packet data units (PDUs), each of the PDUs having a sequence number and a corresponding portion of the redundancy error code;
means for segmenting each of the PDUs into a plurality of segmented messages; and
means for broadcasting the segmented messages to one or more nodes.

16. The apparatus of claim 15, wherein the segmented messages are broadcasted by the node to a second node via the one or more nodes.

17. An apparatus for wireless communication, comprising:
a memory; and
at least one processor coupled to the memory and configured to:
receive a plurality of broadcasted segmented messages from one or more nodes, each segmented message of the segmented messages including redundancy error coding;
reassemble the segmented messages into a plurality of packet data units (PDUs), each PDU of the plurality of PDUs having a sequence number;
determine that one or more PDUs of the plurality of PDUs failed to decode upon attempting to decode each of the PDUs, or that the one or more PDUs are missing from the plurality of PDUs based on the sequence number;
construct at least one PDU of the one or more PDUs based on the redundancy error coding in decoded PDUs other than the at least one PDU; and
reassemble the PDUs into an object based on the sequence number for each PDU.

18. The apparatus of claim 17, wherein to determine that one or more PDUs of the plurality of PDUs failed to decode, the at least one processor is further configured to determine that one or more PDUs are corrupted, and wherein to construct the at least one PDU based on the redundancy error coding in the decoded PDUs, the at least on processor is further configured to reconstruct the at least one PDU based on the redundancy error coding in the decoded PDUs.

19. The apparatus of claim 17, wherein the apparatus receives the plurality of broadcasted segmented messages via different paths in a mesh network from the one or more nodes.

20. The apparatus of claim 17, wherein the segmented messages are reassembled into the plurality of PDUs based on the sequence numbers.

21. The apparatus of claim 17, wherein the at least one PDU is constructed based on the redundancy error coding in the decoded PDUs when a number of the decoded PDUs is greater than a threshold.

22. The apparatus of claim 17, wherein the at least one processor is further configured to request at least one node of the one or more nodes to retransmit one or more PDUs other than the at least one PDU, wherein the at least one PDU is constructed based on PDUs retransmitted from the at least one node combined with PDUs already received.

23. An apparatus for wireless communication at a node, comprising:
a memory; and
at least one processor coupled to the memory and configured to:
code an object based on a redundancy error code;
split the object into a plurality of packet data units (PDUs), each of the PDUs having a sequence number and a corresponding portion of the redundancy error code;
segment each of the PDUs into a plurality of segmented messages; and
broadcast the segmented messages to one or more nodes.

24. The apparatus of claim 23, wherein the segmented messages are broadcasted by the node to a second node via the one or more nodes.

25. A computer-readable medium storing computer executable code, comprising code to:
receive a plurality of broadcasted segmented messages from one or more nodes, each segmented message of the segmented messages including redundancy error coding;
reassemble the segmented messages into a plurality of packet data units (PDUs), each PDU of the plurality of PDUs having a sequence number;
determine that one or more PDUs of the plurality of PDUs failed to decode upon attempting to decode each of the PDUs, or that the one or more PDUs are missing from the plurality of PDUs based on the sequence number;
construct at least one PDU of the one or more PDUs based on the redundancy error coding in decoded PDUs other than the at least one PDU; and
reassemble the PDUs into an object based on the sequence number for each PDU.

26. A computer-readable medium storing computer executable code, comprising code to:
code an object based on a redundancy error code;
split the object into a plurality of packet data units (PDUs), each of the PDUs having a sequence number and a corresponding portion of the redundancy error code;
segment each of the PDUs into a plurality of segmented messages; and
broadcast the segmented messages to one or more nodes.
